(19) United States
(12) Patent Application Publication
(10) Pub. No.: US 2026/0307830 A1
(43) Pub. Date: Oct. 8, 2026

(54) SUBMINIATURE DRONE COMPRISING ROTARY ARTIFICIAL MUSCLE MOTOR AND OPERATING METHOD THEREOF

(71) Applicant: IUCF-HYU (INDUSTRY-UNIVERSITY COOPERATION FOUNDATION HANYANG UNIVERSITY), Seoul (KR)

(72) Inventors: Seon Jeong KIM, Seoul (KR); Jae Sang HYEON, Seoul (KR)

(21) Appl. No.: 19/224,893

(22) Filed: Jun. 2, 2025

(30) Foreign Application Priority Data
Jun. 4, 2024 (KR) 10-2024-0072834

(51) Int. Cl. B64U 50/23; B64C 39/02; B64U 10/14; B64U 30/26; B64U 30/29; B64U 50/30

(52) U.S. Cl. CPC B64U 50/23; B64C 39/028; B64U 10/14; B64U 30/26; B64U 30/29; B64U 50/30

(57) ABSTRACT

A subminiature drone including a rotary artificial muscle motor and a method of operating the same are provided. The subminiature drone includes a plurality of rotary artificial muscle motors that generate rotational force by repeatedly twisting and untwisting depending on whether a voltage is applied, and it alternately secures propulsion through a multicopter structure in which the propellers are rotated in a single direction by one-way clutches, thereby enabling the implementation of an ultra-small-sized drone.

### CLAIM FOR PRIORITY

This application claims priority to Korean Patent Application No. 2024-0072834 filed on Jun. 4, 2024 in the Korean Intellectual Property Office (KIPO), the entire contents of which are hereby incorporated by reference.

### BACKGROUND

### 1. Technical Field

Example embodiments of the present invention relate to a drone, and more specifically, to a subminiature drone and a method of operating the same.

### 2. Related Art

Drones are unmanned flying vehicles guided by radio waves. Drones are divided into fixed-wing and rotary-wing flying vehicle depending on their structural form. Rotary-wing drones are classified into dualcopters, tricopters, quadcopters, hexacopters, and octocopters depending on the number of rotating propellers (or rotors). Drones began to be used for military purposes and are currently being used in the civilian sector for industrial, photography, agricultural, pest control, and hobby purposes. In particular, small drones are being developed for use in remote or extreme environments that are difficult for humans to access. Furthermore, research is being conducted on ultra-small drones that incorporate smart dust technology.

Specifically, to realize ultra-small flying vehicles, there is a need for power sources that can replace conventional electric motors, which are limited in being miniaturized due to their physical size. To address this, attempts have been made to use piezo actuators and dielectric elastomers as propulsion sources for flapping-wing vehicles. However, current ultra-small drones face challenges in miniaturization due to complex power systems and fuel-related issues, necessitating ongoing research and development.

### SUMMARY

Accordingly, example embodiments of the present invention provide an ultra-small or subminiature drone equipped with a rotary-type artificial muscle motor, along with a method for its operation, thereby facilitating the miniaturization of drones.

Example embodiments of the present invention provide a subminiature drone comprising a body unit; an upper fixing member connected to an upper end of the body unit; a lower fixing member connected to a lower end of the body unit; a plurality of artificial muscle motors disposed on the side of the body unit, positioned between and fixed to the upper and lower fixing members, generating rotational force by repeating twisting and untwisting; a plurality of propellers respectively connected to the artificial muscle motors to receive and rotate by the rotational force; a plurality of one-way clutches respectively arranged between the artificial muscle motors and the propellers to allow the propellers to rotate in one direction while restricting rotation in the opposite direction; and a battery unit electrically connected to the artificial muscle motors.

The artificial muscle motor may be a conductive nanomaterial yarn. The conductive nanomaterial yarn may be a carbon nanotube yarn. Each artificial muscle motor may be a carbon nanotube yarn having either a Z-twist twisted in a clockwise direction or an S-twist twisted in a counterclockwise direction. Each of the artificial muscle motors may include a driving motor part comprising a polymer impregnated in a part of the conductive nanomaterial yarn and a return spring part not impregnated with the polymer.

The one-way clutch connected to the artificial muscle motor with a Z-twist may be a counterclockwise clutch allowing counterclockwise rotation and restricting clockwise rotation. The one-way clutch connected to the artificial muscle motor with an S-twist may be a clockwise clutch allowing clockwise rotation and restricting counterclockwise rotation. The propeller connected to the counterclockwise clutch may be a forward propeller, and the propeller connected to the clockwise clutch may be a reverse propeller.

Artificial muscle motors arranged to face each other across the body unit may have different twists: one Z-twist and the other S-twist. The artificial muscle motors may include: a rear artificial muscle motor with an S-twist disposed at the rear of the body unit, a right artificial muscle motor with a Z-twist disposed at the right side, a front artificial muscle motor with a Z-twist disposed at the front side, and a left artificial muscle motor with an S-twist disposed at the left side.

The upper fixing member may include: an upper support frame protruding from the upper end of the body unit; a plurality of upper circular frames coupled to the upper support frame; at least two upper fixing frames radially disposed from each upper circular frame toward its center; and a plurality of upper coupling members disposed at the center of the radially disposed upper fixing frames to fix the top ends of the artificial muscle motors.

The upper circular frames may be located at the same level as the propellers.

The lower fixing member may include: a plurality of lower fixing frames extending from the lower end of the body unit to support the artificial muscle motors; a plurality of lower side wall frames, each having a bore that accommodates one of the artificial muscle motors therein and being supported by one of lower fixing frames; and a plurality of lower coupling members arranged between the lower ends of the artificial muscle motors and the lower fixing frames to fix the artificial muscle motors.

The drone may further include: a first circuit originating from the battery unit and embedded in the upper fixing member, electrically connected to the driving motor part; and a second circuit originating from the battery unit and embedded in the lower fixing member, electrically connected to the return spring part.

Another aspect of the present invention provides an operation method of a subminiature drone comprising: providing the ultra-small drone as described above; applying an ON voltage from the battery unit to both ends of the artificial muscle motors to allow the voltage-applied artificial muscle motors to rotate in a first direction and allow the propellers to rotate in the first direction by transmitting the rotation of the artificial muscle motors through the one-way clutches to the propellers; and removing the applied voltage or applying a reference voltage lower than the ON voltage to the artificial muscle motors to allow the artificial muscle motors to rotate in a second direction opposite to the first direction and restrict the propellers from rotating in the second direction due to the one-way clutches not transmitting the rotation of the artificial muscle motors to the propellers.

The artificial muscle motors may be conductive nanomaterial yarns having either Z- or S-twists, each comprising: a drive motor part with a polymer impregnated in part of the yarn, and a return spring part not impregnated with the polymer. When ON voltage is applied, Joule heating generated in the yarn may cause the polymer in the drive motor part to expand in volume, untwisting the drive motor part in the first direction opposite to the twist. When the voltage is removed or reduced below the ON voltage level, the expanded polymer may contract, allowing the drive motor part to rotate back in the original twist direction which is the second direction.

While the drive motor part rotates in the first direction which is an untwisting direction, the return spring part may twist further to store a rotational energy. While the drive motor part rotates in the second direction which is the original twist direction, the return spring part may transfer the stored rotational energy to the driving motor unit to restore its original twist count.

The one-way clutch associated with the artificial muscle motor having Z-twist may be a counterclockwise clutch allowing only counterclockwise rotation, and the one-way clutch associated with the artificial muscle motor having S-twist may be a clockwise clutch allowing only clockwise rotation. When the driving motor part rotates in the first direction, the one-way clutch transmits rotational force of the driving motor part to rotate the propeller. When the driving motor part rotates in the second direction, the one-way clutch blocks transmission rotational force of the driving motor part to restrict reverse propeller rotation.

The artificial muscle motors may include: a rear artificial muscle motor with an S-twist disposed at the rear of the body unit, a right artificial muscle motor with a Z-twist disposed at the right side, a front artificial muscle motor with a Z-twist disposed at the front side, and a left artificial muscle motor with an S-twist disposed at the left side.

When ON voltage is applied to the rear artificial muscle motor and the front artificial muscle motor at the same level and ON voltage is applied to the right artificial muscle motor and the left artificial muscle motor at the same level, the drone may operate the an ascent mode. When ON voltage applied to the rear artificial muscle motor is higher than ON voltage applied to the front artificial muscle motor, the drone may move from rear to front. When ON voltage applied the right artificial muscle motor is higher than ON voltage applied to the left artificial muscle motor, the drone may move left. When ON voltage applied the left artificial muscle motor is higher than ON voltage applied to the right artificial muscle motor, the drone may move right.

### BRIEF DESCRIPTION OF DRAWINGS

Example embodiments of the present invention will become more apparent by describing in detail example embodiments of the present invention with reference to the accompanying drawings, in which:

FIG. 1 is an isometric view of a subminiature drone including a rotary artificial muscle motor according to an embodiment of the present invention.

FIG. 2 is a cross-sectional view taken along line A-A′ of FIG. 1.

FIG. 3 is an enlarged sectional view of the subminiature drone including a rotary artificial muscle motor according to an embodiment of the present invention.

FIG. 4 is a schematic diagram illustrating the propellers of a subminiature drone including rotary-type artificial muscle motors according to an embodiment of the present invention.

FIG. 5 is a schematic diagram illustrating a one-way clutch disposed between a propeller and an artificial muscle motor according to an embodiment of the present invention.

FIG. 6 is a plan view of the propeller, artificial muscle motor, and one-way clutch according to an embodiment of the present invention.

FIGS. 7a and 7b are schematic diagrams illustrating the one-way clutch according to an embodiment of the present invention.

FIGS. 8a and 8b are schematic diagrams illustrating the rotation of the artificial muscle motor and the resulting rotation of the propeller according to one embodiment of the present invention.

FIGS. 9 and 10 are circuit layout views embedded in a subminiature drone including a rotary-type artificial muscle motor according to an embodiment of the present invention.

FIG. 11 is a schematic diagram illustrating the rotation of a propeller when voltage is applied to an ultrasmall drone including a rotary artificial muscle motor according to an embodiment of the present invention.

FIG. 12 is a schematic diagram illustrating a voltage waveform applied to implement a specific flight mode of an ultrasmall drone including a rotary artificial muscle motor according to an embodiment of the present invention.

### DESCRIPTION OF EXAMPLE EMBODIMENTS

Hereinafter, example embodiments of the present invention will be described in detail with reference to the accompanying drawings.

The present invention allows various modifications and variations, and specific embodiments thereof are exemplified with reference to the drawings and will be described in detail. However, this is not intended to limit the present invention to particular modes of practice, and it is to be appreciated that all changes, equivalents, and substitutes compliant with the spirit or scope of the present invention defined by the appended claims.

It will be understood that when a first element such as a layer, a region, or a substrate is referred to as being “on” a second element, the first element can be directly on the second element or intervening elements may be present.

It will be understood that although terms such as “first” and “second” may be used herein to describe various elements, components, areas, layers, and/or regions, the elements, components, areas, layers, and/or regions should not be limited by these terms.

In the present embodiment, the phrase “A is connected to B” means that A and B may be either physically connected directly or mechanically connected indirectly through other components or parts.

### Embodiment

According to one aspect of the present invention, a subminiature drone including a rotary artificial muscle motor is provided.

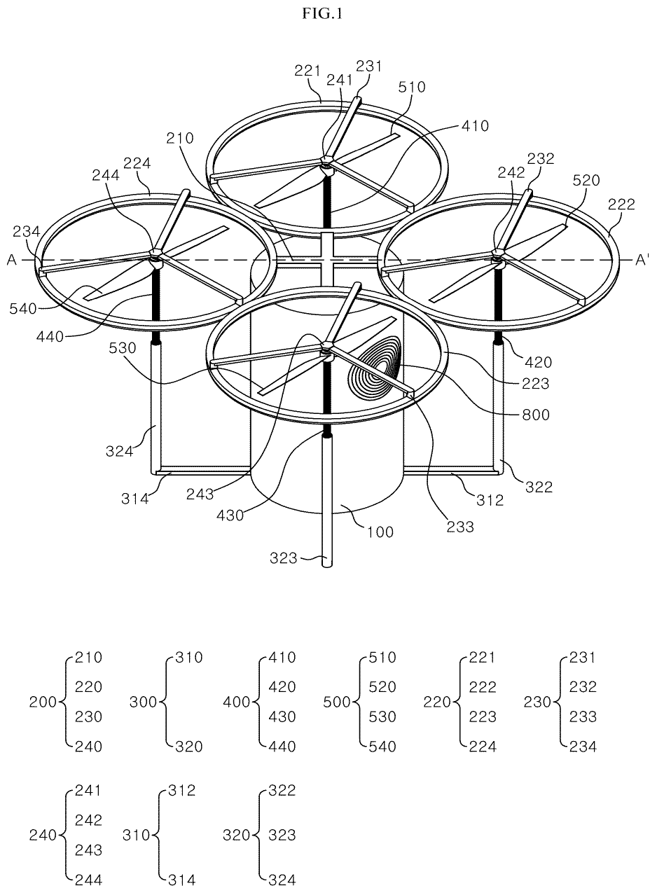

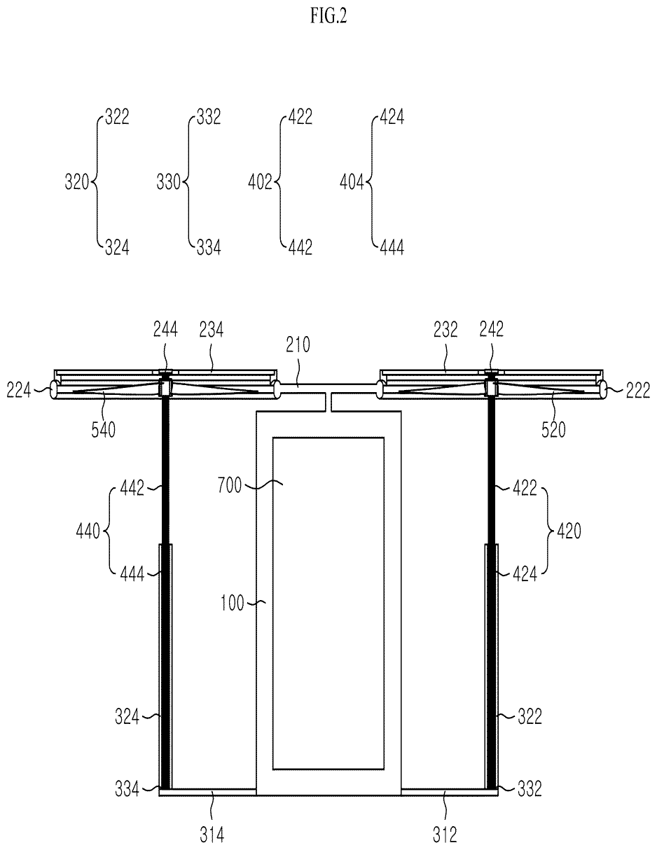

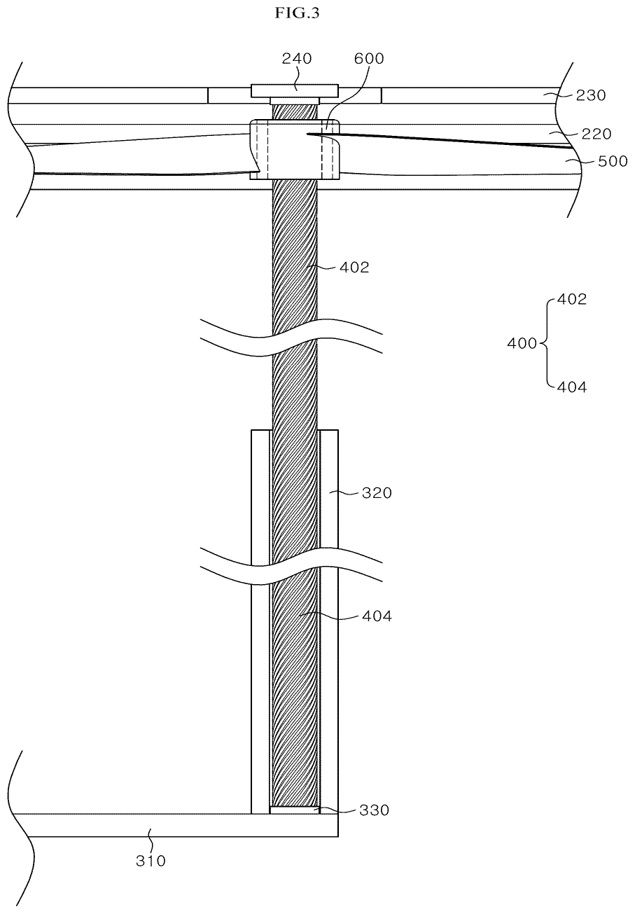

FIG. 1 is an isometric view of an subminiature drone including a rotary artificial muscle motor according to an embodiment of the present invention, FIG. 2 is a cross-sectional view taken along line A-A′ of FIG. 1, and FIG. 3 is an enlarged sectional view of the subminiature drone including a rotary artificial muscle motor according to an embodiment of the present invention. In the drawings, a subminiature drone with a quadcopter structure having four propellers is illustrated; however, the invention is not limited thereto, and the number of propellers may be varied as needed.

Referring to FIGS. 1 through 3, the subminiature drone according to an embodiment of the present invention may include: a body unit 100; an upper fixing member 200 connected to the upper end of the body unit 100; a lower fixing member 300 connected to the lower end of the body unit 100; a plurality of artificial muscle motors 400 disposed on the sides of the body unit 100, arranged between and fixed to the upper fixing member 200 and the lower fixing member 300, and configured to generate rotational force through repeated twisting and untwisting; a plurality of propellers 500, each disposed on the respective artificial muscle motors 400 and rotated by the rotational force transmitted from the motors 400; a plurality of one-way clutches (not shown), each disposed between the artificial muscle motors 400 and the propellers 500 to allow one-way rotation of the propellers 500 while restricting rotation in the opposite direction; and a battery unit 700 electrically connected to the artificial muscle motors 400.

The body unit 100 can function as a body frame for accommodating or supporting other components. Specifically, the body unit 100 can be located at the center of the subminiature drone of the present invention, but is not limited thereto. In addition, the body unit 100 is illustrated as a cylindrical shape having an internal space in FIG. 2, but is not limited thereto and may be configured in various shapes and sizes depending on the embodiment. In one embodiment, the body unit 100 may be formed of a polymer material such as SU-8 in consideration of durability and weight. The weight of the body unit 100 may be 120 to 150 μg. However, it is not limited thereto.

The battery unit 700 may be housed within the internal space of the body unit 100, and considering the possibility of heat generation from the battery unit 700, the body unit 100 may be made of a material including metal or carbon substances with good heat dissipation properties.

The upper fixing member 200 and the lower fixing member 300 can protect the propellers 500 described later and improve the flight efficiency of the drone. At the same time, the upper fixing member 200 and the lower fixing member 300 may serve multiple functions, such as mechanically fixing the artificial muscle motors 400 and supplying power through circuit connections, thereby contributing to the weight reduction of the subminiature drone of the present invention.

Specifically, the upper fixing member 200 may include an upper support frame 210 arranged to protrude from the upper end of the body unit 100; a plurality of upper circular frames 220 coupled to the upper support frame 210; at least two upper fixing frames 230 arranged radially toward the center from each upper circular frame 220; and a plurality of upper coupling members 240 disposed at the center of the radially arranged upper fixing frames 230 to fix the top end of each artificial muscle motor 400.

The upper circular frame 220 may be positioned at the same level as the propellers 500 and can protect the propellers 500.

The number of upper fixing frames 230 arranged within a single upper circular frame 220 may be the same for all upper circular frames 220. In this embodiment, three upper fixing frames 230 are shown arranged within each upper circular frame 220; however, the present invention is not limited thereto. Additionally, the upper fixing frames 230 may be arranged radially from the upper coupling members 240. Specifically, the top end of each artificial muscle motor 400 may be fixed by bonding to the upper coupling member 240 using an adhesive or the like.

The lower fixing member 300 may include a plurality of lower fixing frames 310 extending from the lower end of the body unit 100 to support the artificial muscle motors 400; a plurality of lower sidewall frames 320, each having a bore that accommodates one of the artificial muscle motors 400 therein and being supported by one of lower fixing frames 310; and a plurality of lower coupling members 330 disposed between the lower fixing frames 310 and the bottom ends of the artificial muscle motors 400 to fix the artificial muscle motors 400. Specifically, the bottom ends of the artificial muscle motors 400 may be fixed by bonding to the lower coupling members 330 using an adhesive or the like. An inner surface of the bore of the lower sidewall frame 320 surrounds an outer circumferential surface of the artificial muscle motor 400 while being spaced apart therefrom.

The plurality of lower sidewall frames 320 are respectively connected to the lower fixed frames 310 and each has the artificial muscle motor 400 within the bore while maintaining a predetermined gap between the artificial muscle motor 400 and the inner surface of the bore. This configuration can prevent loosening of the artificial muscle motors 400 caused by the repeated twisting and untwisting. Accordingly, the lower sidewall frames 320 can further support and effectively protect the artificial muscle motors 400.

As described above, the centers of the radially arranged upper fixing frames 230 are coupled to the top ends of the artificial muscle motors 400, and the bottom ends of the artificial muscle motors 400 are coupled to one side of the lower fixing frames 310. This allows the artificial muscle motors 400 to be securely fixed in place. Through this structure, the artificial muscle motors 400 can be stably supported during repeated twisting and untwisting, enabling them to return quickly to their twisted form.

The upper fixing frames 230 are positioned above the propellers 500, and their lengths may be greater than those of the propellers 500. As a result, the propellers 500 can be accommodated within the space defined by the upper fixing frames 230 and the upper circular frames 220, thereby providing protection for the propellers.

The level of the upper support frame 210 may be the same as the level of the upper circular frames 220.

In one embodiment, the upper fixing member 200 and the lower fixing member 300 may be formed of a polymer material such as SU-8, in consideration of durability and weight. The weight of the upper fixing member 200 or the lower fixing member 300 may be between 120 and 150 μg. In this case, the diameter and height of the subminiature drone of the present invention may each be formed to be less than 1 cm. However, the present invention is not limited thereto.

Each of the artificial muscle motors 400 may be a linear structure motor that generates rotational force through repeated twisting and untwisting. In one example, the artificial muscle motor 400 may be a conductive nanomaterial yarn formed by twisting conductive nanomaterials, where the nanomaterials may include carbon-based nanomaterials such as carbon nanotubes or graphene. Specifically, the artificial muscle motor 400 may be a carbon nanotube yarn.

In one specific embodiment, the artificial muscle motor 400 may be a carbon nanotube yarn twisted either in a Z-twist (clockwise) or an S-twist (counterclockwise). The carbon nanotube yarn may be formed by twist-spinning a carbon nanotube sheet, in which the carbon nanotubes are aligned in nearly the same direction, obtained from a carbon nanotube forest where the nanotubes grow in a nearly uniform orientation on a substrate. The sheet may be twisted into an Archimedean or dual-Archimedean structure. However, the twisted configuration is not limited thereto. In one embodiment, the carbon nanotube yarn may have a height of 250 to 350 μm and a density of 40 to 70 mg/cm³.

Specifically, the carbon nanotube yarn may have a twisted form with properties that vary depending on the direction and number of twists. Generally, a Z-twist refers to yarn twisted in the leftward, i.e., clockwise direction, while an S-twist refers to yarn twisted in the rightward, i.e., counterclockwise direction.

Each of the artificial muscle motors 400 may include a carbon nanotube yarn with at least 3,000 TPM (twists per meter). Here, TPM refers to the number of twists per meter of yarn. In another embodiment, each of the artificial muscle motors 400 may be in a coiled state, where the twisted yarn is further twisted such that the twisted yarns overlap and form coils. However, a non-coiled state of the artificial muscle motor may be more advantageous for generating rotational force.

As described above, in one embodiment, by using carbon nanotube yarn with at least 3,000 TPM as the artificial muscle motors 400, sufficient twisting and untwisting can be repeatedly generated to produce rotational force, thereby effectively providing lift for driving a subminiature drone. If the twist count of the carbon nanotube yarn used in the artificial muscle motors 400 is less than 3,000 TPM, it may not generate enough rotational force to power the subminiature drone. In another embodiment, the artificial muscle motors 400 may be composed of carbon nanotube yarn with a twist count ranging from 3,000 to 10,000 TPM.

In one embodiment, each of the artificial muscle motors 400 may have a length of 5 to 10 mm, an average diameter of 50 to 100 μm, and a weight of 20 to 100 μg, though it is not limited thereto. Additionally, each of the artificial muscle motors 400 may have a maximum rotation angle of 70 to 90° /mm, a maximum rotational speed of 8,000 to 12,000 RPM, and a maximum output torque of 6 to 9 Nm/kg, although these values are not limiting. Furthermore, the artificial muscle motors 400 may have high electrical conductivity, for example, up to 400 S/cm or less, though this is not restrictive.

Some of the plurality of artificial muscle motors 400 may have Z-twists, while others may have S-twists. In one example, in a pair of artificial muscle motors 400 facing each other across the center body unit 100, one may have a Z-twist and the other may have an S-twist. In one specific embodiment, the artificial muscle motors 400 may include: a rear artificial muscle motor 410 disposed at the rear of the body unit 100 and having an S-twist, a right artificial muscle motor 420 disposed on the right side of the body unit 100 and having a Z-twist, a front artificial muscle motor 430 disposed at the front of the body unit 100 and having a Z-twist, and a left artificial muscle motor 440 disposed on the left side of the body unit 100 and having an S-twist. In one embodiment of the present invention, by arranging the artificial muscle motors 400 in the above-described configuration, the propulsion force of the drone can alternately be maintained by the artificial muscle motors 400, even during the stop or stationary phase of the propellers 500 caused by the one-way clutches (not shown), which occurs during a twist recovery process of the artificial muscle motors 400, as will be described later.

Each linear artificial muscle motor 400 may include, in the longitudinal direction, a driving motor part 402 and a return spring part 404. In other words, the artificial muscle motor 400 may include a driving motor part 402, formed from a portion of the conductive nanomaterial yarn such as carbon nanotube yarn impregnated with a polymer, and a return spring part 404, which is a portion of the yarn not impregnated with the polymer.

In FIG. 2, as examples of the driving motor part 402, only a right driving motor part 422 included in the right artificial muscle motor 420 and a left driving motor part 442 included in the left artificial muscle motor 440 are illustrated. However, each of the artificial muscle motors 400 may be provided with the driving motor part 402. Likewise, as examples of the return spring part 404, only a right return spring part 424 included in the right artificial muscle motor 420 and a left return spring part 444 included in the left artificial muscle motor 440 are illustrated; however, each of the artificial muscle motors 400 may be provided with the return spring part 404.

The driving motor part 402 and the return spring part 404 constituting the artificial muscle motor 400 may have a size ratio ranging from 9:1 to 5:5. In other words, the return spring part 404 may be 10% to 50% of the total length of the driving motor part 402 and the return spring part 404 within the artificial muscle motor 400. If the return spring part 404 is smaller than 10%, it may be difficult for the return spring part 404 to quickly restore the driving motor part 402 to its twisted state, reducing stability against repeated twisting and untwisting. Conversely, if the return spring part 404 is larger than the 50%, the shortened driving motor part 402 may result in a decrease in the rotational force generated through the repeated twisting and untwisting.

In this way, one embodiment of the present invention integrates the driving motor part 402 and the return spring part 404 into a single artificial muscle motor 400 by only varying the impregnation of a polymer within a single strand of conductive nanomaterial yarn, specifically carbon nanotube yarn. This allows the artificial muscle motor 400 to more effectively transition between twisted and untwisted states and vice versa.

The polymer may be impregnated into the conductive nanomaterial yarn, specifically the carbon nanotube yarn, and may be located among the multiple conductive nanomaterials constituting the conductive nanomaterial yarn, specifically carbon nanotubes constituting the carbon nanotube yarn, within the yarn. The polymer may include a polymer material that undergoes a phase change within a specific temperature range, particularly a polymer having a glass-transition temperature (Tg) in the range of 40 to 80° C. Generally, the glass-transition temperature refers to the temperature at which the molecules composing the polymer become active and begin to move due to temperature.

For example, the polymer may comprise at least one material selected from the group consisting of paraffin wax, polystyrene-poly(ethylene-butylene)-polystyrene copolymer, polyurethane, and perfluorosulfonic acid polyethylene oxide.

The propellers 500 may be coupled to an upper portion of the artificial muscle motors 400, specifically to the driving motor parts 402, such that rotational force generated by the driving motor parts 402 may be transmitted to the propellers 500, thereby enabling rotation thereof.

In one embodiment, the propellers 500 may include a rear propeller 510 provided on a rear artificial muscle motor 410 disposed at the rear of the body unit 100, a right propeller 520 provided on a right artificial muscle motor 420 disposed at the right side of the body unit 100, a front propeller 530 provided on a front artificial muscle motor 430 disposed at the front of the body unit 100, and a left propeller 540 provided on a left artificial muscle motor 440 disposed at the left side of the body unit 100.

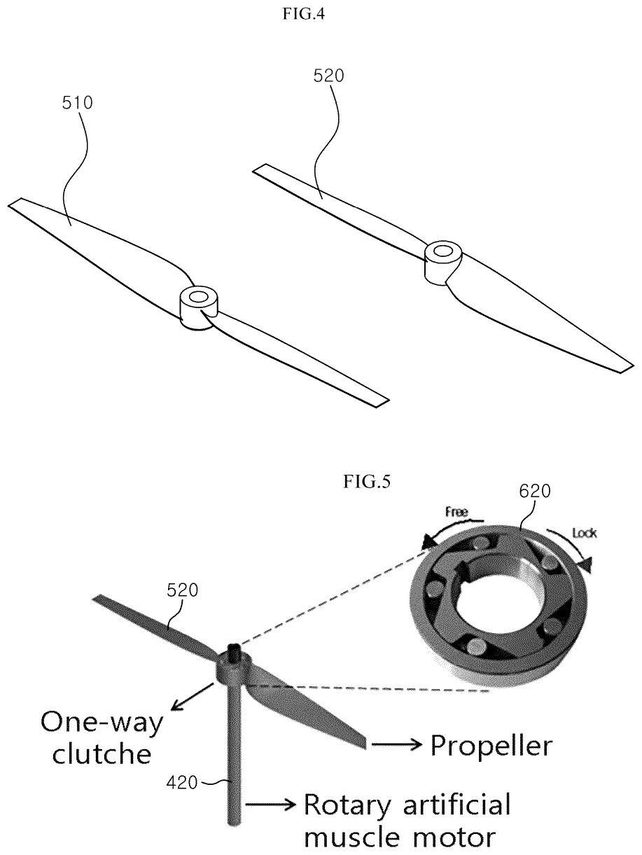

FIG. 4 is a schematic diagram illustrating the propellers of a subminiature drone including rotary-type artificial muscle motors according to an embodiment of the present invention.

Referring to FIGS. 1 to 3 and FIG. 4 together, a forward (CCW, Counter Clockwise) propeller can be connected to an artificial muscle motor with a Z-twist. The forward propeller can push air downward when rotating in a counterclockwise direction. As an example, the right propeller 520 and the front propeller 530, which are arranged on the right artificial muscle motor 420 having a Z-twist and the front artificial muscle motor 430 having a Z-twist respectively, may be forward propellers. The blades of the forward propellers may be configured such that the upper part is tilted counterclockwise relative to the lower part. Accordingly, when the right artificial muscle motor 420 and the front artificial muscle motor 430 with Z-twists rotate counterclockwise, the forward propellers also rotate counterclockwise and push air downward.

In addition, a reverse (CW, Clockwise) propeller can be connected to an artificial muscle motor with an S-twist. The reverse propeller can push air downward when rotating clockwise. As an example, the rear propeller 510 and the left propeller 540, which are arranged on the rear artificial muscle motor 410 having an S-twist and the left artificial muscle motor 440 having an S-twist respectively, may be reverse propellers. The blades of the reverse propellers may be configured such that the upper part is tilted clockwise relative to the lower part. Accordingly, when the rear artificial muscle motor 410 and the left artificial muscle motor 440 with S-twists rotate clockwise, the reverse propellers also rotate clockwise and push air downward.

In one embodiment, the propellers 500 may be formed from polymer materials such as SU-8, considering durability and weight. The diameter of the propellers 500 may be between 7 and 9 mm, the thickness may range from 400 μm to 1.5 mm, and the weight may be between 50 and 100 ng. The propellers 500 may be composed of 2 to 4 blades, taking into account the target lift and motor output, and the blade pennation angle may be formed between 15° and 45°. Preferably, the propellers 500 may be formed with a low blade angle of 5° to 25° to maximize lift.

The propellers 500 may be fabricated based on conventional ultraviolet (UV) lithography techniques, using tilted lithography or inclined lithography methods. Alternatively, two-photon beam lithography, holographic lithography techniques, or nanoscale precision additive manufacturing methods such as nano-scribe may also be used.

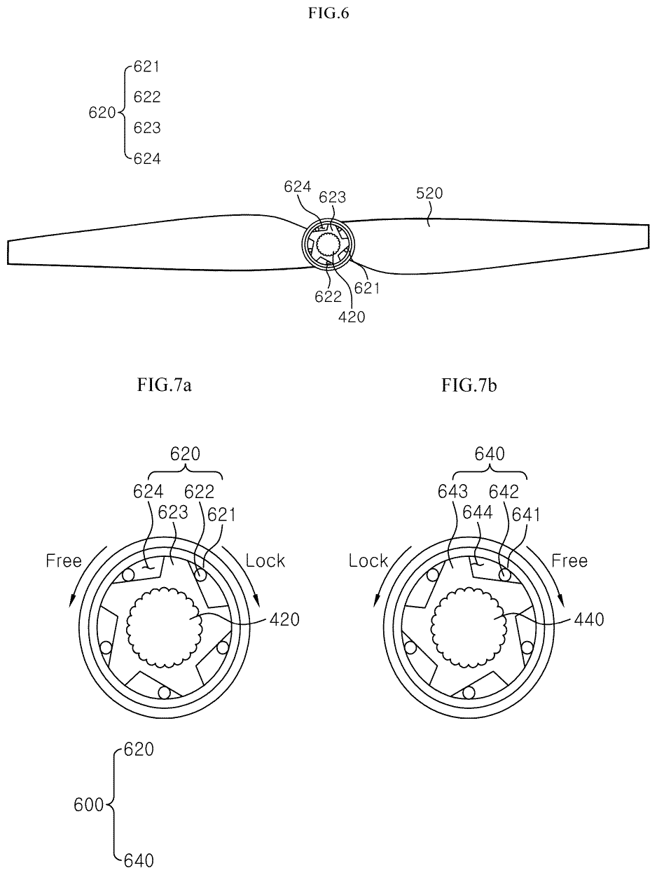

FIG. 5 is a schematic diagram illustrating a one-way clutch disposed between a propeller and an artificial muscle motor according to an embodiment of the present invention, and FIG. 6 is a plan view of the propeller, artificial muscle motor, and one-way clutch according to an embodiment of the present invention. FIGS. 7a and 7b are schematic diagrams illustrating the one-way clutch according to an embodiment of the present invention.

Referring to FIGS. 1, 5, 6, and 7a together, the first one-way clutch 620 is disposed between the artificial muscle motor having a Z-twist and the forward propeller, such that when the artificial muscle motor untwists and rotates counterclockwise, rotational force is transmitted to the forward propeller, but when the artificial muscle motor recovers the twist and rotates clockwise, rotational force is not transmitted to the forward propeller.

Referring to FIGS. 1, 5, 6, and 7b together, the second one-way clutch 640 is disposed between the artificial muscle motor having an S-twist and the reverse propeller, such that when the artificial muscle motor untwists and rotates clockwise, rotational force is transmitted to the reverse propeller, but when the artificial muscle motor recovers the twist and rotates counterclockwise, rotational force is not transmitted to the reverse propeller.

In other words, the one-way clutch connected to the artificial muscle motor with the Z-twist is a counterclockwise clutch that only allows rotation in the counterclockwise direction and restricts rotation in the clockwise direction, and the one-way clutch connected to the artificial muscle motor with the S-twist is a clockwise clutch that only allows rotation in the clockwise direction and restricts rotation in the counterclockwise direction.

For example, the first one-way clutch 620 may be disposed between the right artificial muscle motor 420 with Z-twist and the right propeller 520, and between the front artificial muscle motor 430 with Z-twist and the front propeller 530, and the second one-way clutch 640 may be disposed between the rear artificial muscle motor 410 with S-twist and the rear propeller 510, and between the left artificial muscle motor 440 with S-twist and the left propeller 540.

For example, each of the one-way clutches 620, 640 may include an outer ring 621, 641 coupled to the propeller 500, a plurality of rollers 622, 642 coupled inside the outer ring 621, 641 and supported by an elastic body (not shown), and an inner ring 623, 643 arranged coaxially with the outer ring 621, 641 that accommodates the rollers 622, 642 and has roller guide grooves 624, 644 that guide the rollers' movement in the circumferential direction of the outer ring 621, 641. In this case, the roller guide grooves 624, 644 have an inclined surface on one side where the groove area decreases in one direction.

Using the above structure, the one-way clutches 620, 640 can transmit the rotational force of the artificial muscle motor 400 to the propeller 500 while restricting the rotation of the propeller 500 to rotate only in one direction.

Specifically, the first one-way clutch 620 may allow the movement of the rollers 622 only in the counterclockwise direction by the roller guide groove 624, which has an inclined surface causing the groove area to gradually decrease counterclockwise. As a result, the counterclockwise rotational force of the artificial muscle motor 420 may be transmitted to the propeller, but the clockwise rotational force may not be transmitted to the propeller. Conversely, the second one-way clutch 640 may allow the movement of the rollers 642 only in the clockwise direction by the roller guide groove 644, which has an inclined surface causing the groove area to gradually decrease clockwise. Thus, the clockwise rotational force of the artificial muscle motor 440 may be transmitted to the propeller, but the counterclockwise rotational force may not be transmitted to the propeller.

In other words, since the artificial muscle motors 400 of the present invention may rotate in different directions depending on their inherent twist directions when voltage is applied, the one-way clutches 620 and 640 that transmit and control their rotational forces may also be configured to match the twist directions of the artificial muscle motors 400.

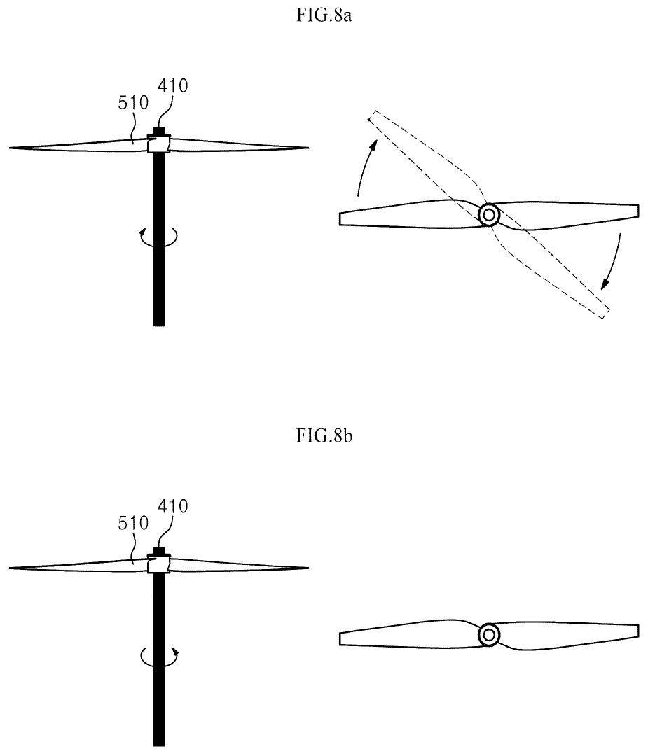

FIGS. 8a and 8b are schematic diagrams illustrating the rotation of the artificial muscle motor and the resulting rotation of the propeller according to one embodiment of the present invention.

Referring to FIG. 8a, as an example, when the driving motor unit (not shown in the figure) of the rear artificial muscle motor 410 with an S-twist rotates clockwise as the twist is released by voltage application, the rear propeller 510 may also rotate clockwise. Specifically, when the driving motor unit of the rear artificial muscle motor 410 with the S-twist rotates clockwise, the internal ring, external ring of the one-way clutch (not shown in the figure) disposed between the rear artificial muscle motor 410 and the rear propeller 510, and the rear propeller 510 may all rotate in the same direction together with the driving motor unit.

Referring to FIG. 8b, when the driving motor unit of the rear artificial muscle motor 410 with the S-twist is re-twists and therefore rotated counterclockwise by a restoring force provided from the return spring unit (not shown in the figure) disposed below the driving motor unit, the rotation of the rear propeller 510 may be restricted. Specifically, when the driving motor unit of the rear artificial muscle motor 410 with the S-twist rotates counterclockwise, only the internal ring of the one-way clutch rotates together with the driving motor unit, and the rotational force of the driving motor unit may not be transmitted to the external ring of the one-way clutch due to the action of the roller guide groove and rollers. Accordingly, the rotation of the rear propeller 510 may be restricted. As described above, the plurality of one-way clutches 620 and 640 may effectively control the rotation of the propellers.

Referring again to FIGS. 1 through 3, battery unit 700 may be disposed on a portion of body unit 100, specifically within an internal space of body unit 100, and may be electrically connected to artificial muscle motors 400. Specifically, one side of battery unit 700 may be electrically connected to the uppermost end of driving motor unit 402, and the other side of battery unit 700 may be electrically connected to the lowermost end of return spring unit 404. Battery unit 700 may have high-power and high-safety battery materials such as a lithium titanate (LTO) battery, a lithium iron phosphate (LFP) battery, or a nickel-cadmium (NiCd) battery, although it is not limited thereto.

Referring again to FIG. 1, a wireless signal transceiver unit 800 may be embedded in a portion of the outermost wall of body unit 100. Wireless signal transceiver unit 800 may be provided to transmit and receive wireless signals so that a user can remotely control the ultracompact drone according to the present invention. Wireless signal transceiver unit 800 may employ materials commonly used for such transceiver components.

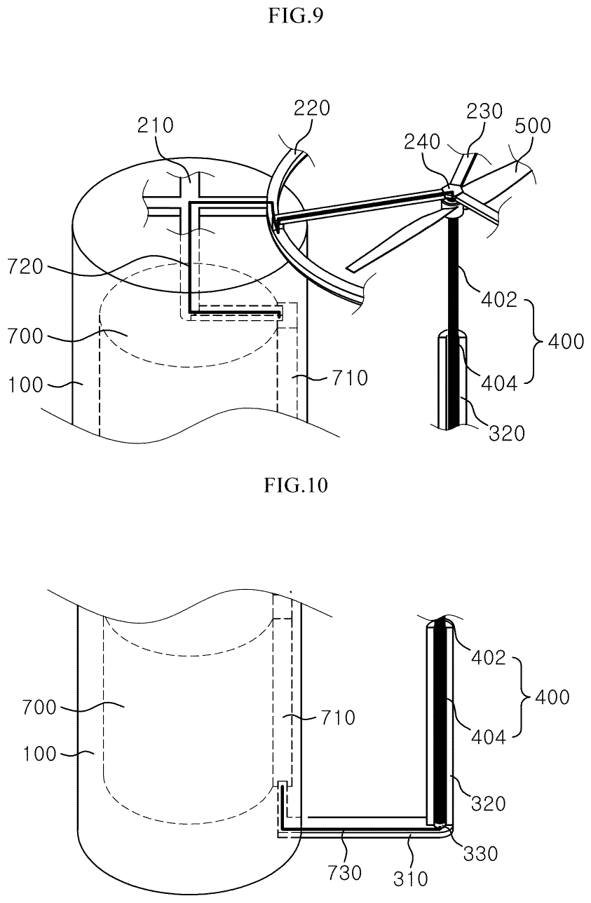

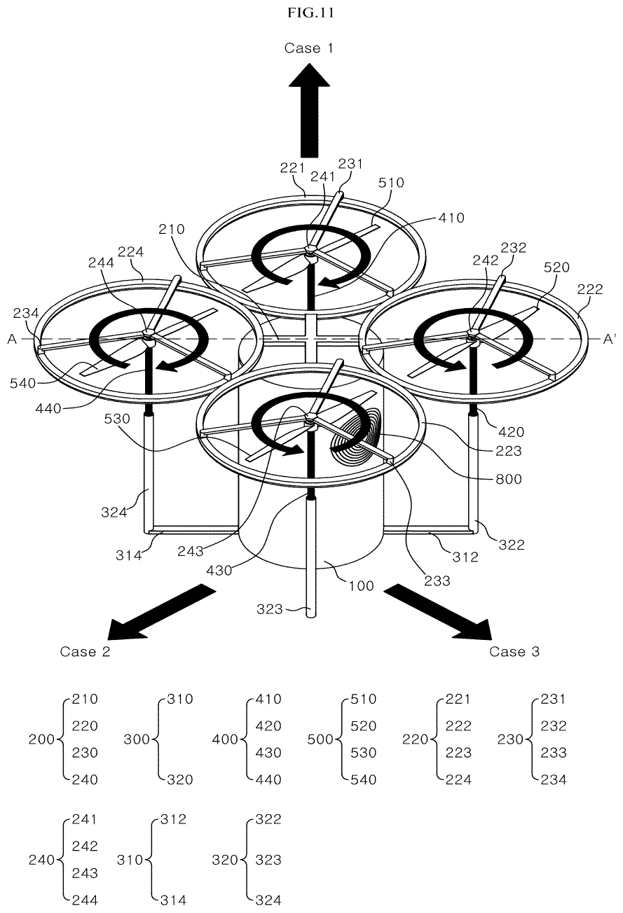

FIGS. 9 and 10 are circuit layout views embedded in a subminiature drone including a rotary-type artificial muscle motor according to an embodiment of the present invention.

Referring to FIGS. 9 and 10 in conjunction with FIG. 1, a high-voltage pulse wave generation control unit 710 may be disposed on one side of the battery unit 700. The high-voltage pulse wave generation control unit 710 may be electrically connected to the battery unit 700 and may generate high-voltage pulse waves using the power received from the battery unit 700.

The high-voltage pulse wave generation control unit 710 may be electrically connected to the artificial muscle motors 400 to deliver the generated high-voltage pulse waves to them. To this end, a first circuit 720, derived from the battery unit and embedded in the upper fixing members to be electrically connected to the driving motor unit, and a second circuit 730, derived from the battery unit and embedded in the lower fixing members to be electrically connected to the return spring unit, may be further included.

Specifically, as shown in FIG. 9, the first circuit 720 connected to one side of the high-voltage pulse wave generation control unit 710, which is connected to the battery unit 700, may be electrically connected to the driving motor unit 402 sequentially through the upper support frame 210, the upper circular frame 220, the upper fixing frame 230, and the upper coupling member 240.

Additionally, as shown in FIG. 10, a second circuit 730 connected to the opposite side of the high-voltage pulse generation control unit 710, which is connected to the battery unit 700, may be electrically connected to the return spring unit 404 via the lower fixing frame 310 and the lower coupling member 330.

In addition, various sensors (not shown) may be provided on the inner or outer side of the body unit 100 depending on the embodiment. The subminiature of the present invention may be implemented as a micro smart dust drone by being equipped with various sensors.

Another aspect of the present invention may provide a method for operating a subminiature.

Referring to FIGS. 1 to 3, the method may include: applying an ON voltage from the battery unit 700 to both ends of the artificial muscle motors 400 to allow the voltage-applied artificial muscle motors 400 to rotate in a first direction and allow the propellers 500 to rotate in the first direction by transmitting the rotation of the artificial muscle motors 400 through the one-way clutches 600 to the propellers 500; and removing the applied voltage or applying a reference voltage lower than the ON voltage to the artificial muscle motors 400 to allow the artificial muscle motors 400 to rotate in a second direction opposite to the first direction and restrict the propellers 500 from rotating in the second direction due to the one-way clutches 600 not transmitting the rotation of the artificial muscle motors 400 to the propellers 500.

Hereinafter, the operation method of the ultrasmall drone of the present invention will be described in detail.

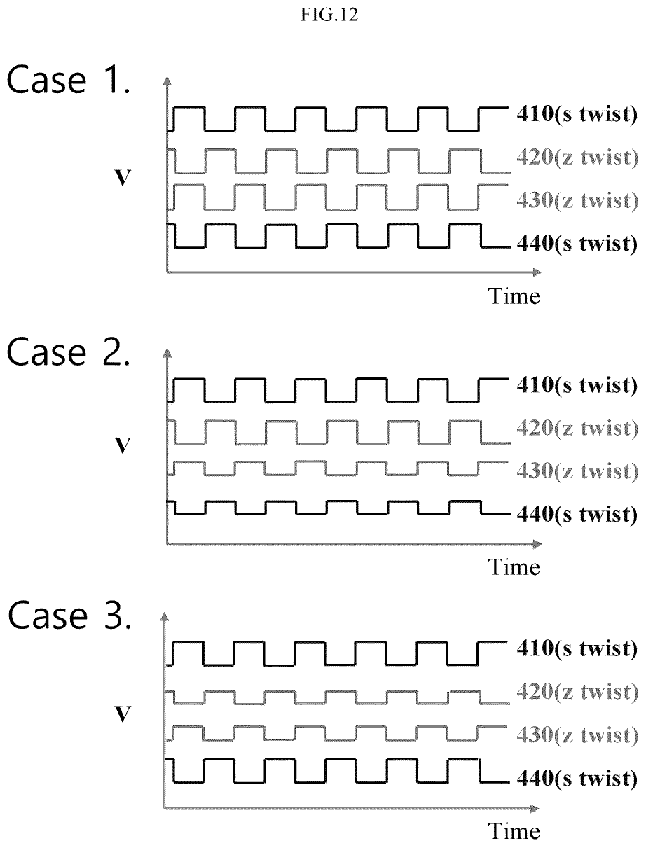

FIG. 11 is a schematic diagram illustrating the rotation of a propeller when voltage is applied to an ultrasmall drone including a rotary artificial muscle motor according to an embodiment of the present invention.

Referring to FIG. 11 together with FIGS. 1 to 3, a user may drive or stop driving the battery unit 700 through the wireless signal transceiver unit 800 provided in the body unit 100. When the operation of the battery unit 700 starts, the battery unit 700 supplies power to the high-voltage pulse wave generation control unit 710 electrically connected thereto, and the high-voltage pulse wave generation control unit 710 generates a high-voltage pulse wave to apply voltage to both ends of the artificial muscle motors 400. In addition, when the operation of the battery unit 700 is stopped, the voltage applied to the artificial muscle motors 400 may be removed.

When the driving voltage, specifically the ON voltage, is applied to the artificial muscle motors 400, Joule heating generated in conductive nanomaterials, specifically carbon nanotube yarns, causes the volume of the polymer within driving motor units 402 included the artificial muscle motors 400 to expand, causing the driving motor unit 402 to rotate in the reverse direction of the twist (clockwise for S-twist, counterclockwise for Z-twist) and become untwisted.

As a result, the propellers 500 attached to the outer upper portions of the plurality of driving motor parts 402 may rotate in the opposite direction to the twisting direction of the driving motor parts 402 (i.e., clockwise for S-twist and counterclockwise for Z-twist). At this time, since the total number of twists in the artificial muscle motors 400 must be maintained, the return spring parts 404 may further twist to store a rotational energy. In other words, when a voltage is applied to the artificial muscle motors 400, the driving motor parts 402 may rotate in the untwisting direction while the return spring parts 404 rotate may further twist.

As shown in FIG. 11, the artificial muscle motors 400 of the ultrasmall drone are disposed at the rear, right, front, and left sides of the body 100, and may include: a rear artificial muscle motor 410 having an S-twist disposed at the rear of the body 100; a right artificial muscle motor 420 having a Z-twist disposed at the right side of the body 100; a front artificial muscle motor 430 having a Z-twist disposed at the front of the body 100; and a left artificial muscle motor 440 having an S-twist disposed at the left side of the body 100.

Referring to FIGS. 11 and 2 together, when a voltage is applied to both ends of the artificial muscle motors 400, the driving motor parts included in the right and front artificial muscle motors 420, 430 with Z-twist may rotate in the untwisting direction (i.e., counterclockwise for a Z-twist), thereby rotating the right propeller 520 and the front propeller 530 which are forward propellers in the counterclockwise direction. In addition, the driving motor parts included in the rear and left artificial muscle motors 410, 440 with S-twist may rotate in the untwisting direction (i.e., clockwise for an S-twist), thereby rotating the rear propeller 510 and the left propeller 540 which are reverse propellers in the clockwise direction.

Specifically, when a driving voltage, more precisely an ON voltage, derived from the battery unit 700 is applied to both ends of the artificial muscle motors 400, the driving motor parts 402 of the voltage-applied artificial muscle motors 400 may rotate in the untwisting direction. A one-way clutch (not shown) transmits the rotational force of the artificial muscle motors 400 to the propellers 500, thereby enabling the rotation of the propellers 500. Accordingly, as the propellers 500 rotate and push the air downward, the ultrasmall drone according to an embodiment of the present invention can ascend. When the driving voltage is applied to the artificial muscle motors 400, the return spring parts 404 of the voltage-applied artificial muscle motors 400 may be further twisted in the twisting direction.

Thereafter, when the voltage applied to the artificial muscle motors 400 is removed or a reference voltage lower than the driving voltage is applied, the expanded polymer contracts, and the previously untwisted driving motor part 402 may rotate in the original twisting direction (i.e., counterclockwise for an S-twist, clockwise for a Z-twist).

This occurs because, the return spring part 404, which had been further twisted and stored the rotational energy when ON voltage was applied to the artificial muscle motor 400, may rotate to return to its original twist number, and at this time, since the total twist of the artificial muscle motor 400 must be maintained, rotating of the return spring part 404 to return to its original twist number may transfer the stored rotational energy to the driving motor part 402, thereby allowing the driving motor part 402 to return more quickly to its original twist direction (i.e., counterclockwise for an S-twist, clockwise for a Z-twist). This action of the return spring part 404 may be due to the fact that the upper and lower ends of the artificial muscle motor 400 are fixed and the return spring part 404 does not contain impregnated polymer material, unlike the driving motor part 402.

As described above, when the voltage applied to the artificial muscle motors 400 is removed or a reference voltage lower than the driving voltage is applied, the rotational force stored in the return spring part 404 may be transferred to the driving motor part 402 as the return spring part 404 returns to its original twisted state, thereby enabling a faster return of the driving motor part 402.

Referring to FIGS. 7 and 11, when the voltage applied to the artificial muscle motors 400 is removed or a reference voltage lower than the driving voltage, specifically, the ON voltage, is applied, the driving motor part 402 rotates in the twisting direction. However, the rotational force of the driving motor part 402 may be controlled by the one-way clutch 600, thereby preventing the propellers 500 from rotating and causing the propellers 500 to transition into a stationary state.

In other words, to compensate for the drone's propulsion loss during the stationary state of the propellers, in embodiments of the present invention, a plurality of artificial muscle motors and propellers are provided, with some rotating in the forward direction and others in the reverse direction, thereby enabling alternating generation of thrust and ensuring stable flight of the drone.

Additionally, in the ultrasmall drone of the present invention, the user can control the ascent, descent, and turning of the drone by modulating the frequency and pulse width of the pulse voltage applied to each of the artificial muscle motors 400 through the wireless signal transceiver 800 and the high-voltage pulse waveform generation controller 710.

FIG. 12 is a schematic diagram illustrating a voltage waveform applied to implement a specific flight mode of an ultrasmall drone including a rotary artificial muscle motor according to an embodiment of the present invention.

Referring to FIGS. 11 and 12, the flight modes of the ultrasmall drone of the present invention include ascent mode (Case 1), left-turn mode (Case 2), and right-turn mode (Case 3). During left or right turns, the upward thrust increases as the difference in pulse levels of the applied ON voltage decreases, while the degree of rotation increases as the pulse level difference increases.

For example, as illustrated in FIG. 11, the drone's ascent and rotation will now be described with a drone including a rear artificial muscle motor 410 with an S-twist at the rear of the body unit 100, a right artificial muscle motor 420 with a Z-twist on the right side of the body unit 100, a front artificial muscle motor 430 with a Z-twist at the front of the body unit 100, and a left artificial muscle motor 440 with an S-twist on the left side of the body unit 100.

Referring to FIG. 12, it can be seen that a first interval and a second interval are alternately repeated. In the first interval, an ON voltage is applied to the rear artificial muscle motor 410 and the front artificial muscle motor 430 while an OFF voltage which is a ground voltage or a reference voltage lower than the ON voltage is applied to the right artificial muscle motor 420 and the left artificial muscle motor 440. In the second interval, an ON voltage is applied to the right artificial muscle motor 420 and the left artificial muscle motor 440 while an OFF voltage which is a ground voltage or a reference voltage lower than the ON voltage is applied to the rear artificial muscle motor 410 and the front artificial muscle motor 430.

In the first interval, upward thrust may be generated by the propellers connected to the rear artificial muscle motor 410 and the front artificial muscle motor 430, which face each other with respect to the body unit 100, while the propellers connected to the right artificial muscle motor 420 and the left artificial muscle motor 440 may remain in a stationary state. In the second interval, upward thrust may be generated by the propellers connected to the right artificial muscle motor 420 and the left artificial muscle motor 440, which also face each other with respect to the body unit 100, while the propellers connected to the rear artificial muscle motor 410 and the front artificial muscle motor 430 may remain in a stationary state.

When the ON voltage is applied to the rear artificial muscle motor 410 and the front artificial muscle motor 430 at the same level and the ON voltage is applied to the right artificial muscle motor 420 and the left artificial muscle motor 440 at the same level, the drone may operate the an ascent mode (Case 1).

When the ON voltage applied to the rear artificial muscle motor 410 is higher than the ON voltage applied to the front artificial muscle motor 430, the drone moves from rear to front. In addition, the ON voltage applied the right artificial muscle motor 420 is higher than the ON voltage applied to the left artificial muscle motor 440, the drone may move left, thereby operating in the left-turn mode (Case 2).

When the ON voltage applied to the rear artificial muscle motor 410 is higher than the ON voltage applied to the front artificial muscle motor 430, the drone moves from rear to front. In addition, the ON voltage applied the left artificial muscle motor 440 is higher than the ON voltage applied to the right artificial muscle motor 420, the drone may move right, thereby operating in the right-turn mode (Case 3).

Specifically, high-voltage pulse waves of 0.5 to 1.0 V/mm may be applied to the artificial muscle motors 400 through the first circuit 720 and the second circuit 730 from the high-voltage pulse waveform generation controller 710. These high-voltage pulses may have a frequency of 5 to 15 Hz, and depending on the flight conditions of the drone, Pulse Width Modulation (PWM) or Pulse Frequency Modulation (PFM) may be applied to the rotary artificial muscle motors.

As described above, the present invention provides a novel form of ultrasmall, ultralight rotary artificial muscle motor based on carbon nanotube yarn, capable of replacing conventional electric motors which cannot be miniaturized. Furthermore, the wireless signal transceiver integrated circuit and various sensors can be easily mounted on the body unit using MEMS (Microelectromechanical Systems) technology, enabling effective integration with smart dust technologies, and allowing for the easy realization of ultrasmall smart dust drones.

These ultrasmall smart dust drones can contribute to maintaining a safe living environment by observing air, soil, and water pollution in ecosystems, and are also expected to be actively used for special purposes such as reconnaissance and hazard detection, due to their small size, low noise flight, and radar-evading capabilities.

According to the above-described embodiment of the present invention, by applying a rotary artificial muscle motor, which generates rotational force through repeated twisting and untwisting, to the subminiature drone, the motor structure for driving the drone can be simplified. Accordingly, the subminiature drone can be implemented with a size of less than 1 cm. In addition, the subminiature drone of the present invention can effectively implement flight by restricting the rotation of the propeller connected to the rotary artificial muscle motor to a unidirectional (or one-way) rotation through a one-way clutch. Furthermore, the subminiature drone of the present invention is configured with a multicopter structure, allowing stable flight by alternately securing thrust even during the stationary phases of the unidirectionally rotating propellers. Moreover, the subminiature drone of the present invention can be easily controlled by the user by adjusting the application of ON voltage and the pulse level of the applied voltage through a high-voltage pulse wave generation control unit connected to a wireless signal transmission/reception unit.

The technical effects of the present invention are not limited to those described above, and other technical effects that are not described may become apparent to those of ordinary skill in the art based on the following descriptions.

1. A subminiature drone comprising:
a body unit;
an upper fixing member connected to an upper end of the body unit;
a lower fixing member connected to a lower end of the body unit;
a plurality of artificial muscle motors disposed on the side of the body unit, positioned between and fixed to the upper and lower fixing members, generating rotational force by repeating twisting and untwisting;
a plurality of propellers respectively connected to the artificial muscle motors to receive and rotate by the rotational force;
a plurality of one-way clutches respectively arranged between the artificial muscle motors and the propellers to allow the propellers to rotate in one direction while restricting rotation in the opposite direction ; and
a battery unit electrically connected to the artificial muscle motors.

2. The subminiature drone of claim 1, wherein the artificial muscle motors are conductive nanomaterial yarns.

3. The subminiature drone of claim 2, wherein the conductive nanomaterial yarns are carbon nanotube yarns.

4. The subminiature drone of claim 2, wherein each of the artificial muscle motors include a driving motor part comprising a polymer impregnated in a part of the conductive nanomaterial yarn and a return spring part not impregnated with the polymer.

5. The subminiature drone of claim 4, further comprising:
a first circuit originating from the battery unit and embedded in the upper fixing member, electrically connected to the driving motor part; and
a second circuit originating from the battery unit and embedded in the lower fixing member, electrically connected to the return spring part.

6. The subminiature drone of claim 1, wherein each of the artificial muscle motors has either a Z-twist twisted in a clockwise direction or an S-twist twisted in a counterclockwise direction.

7. The subminiature drone of claim 6, wherein the one-way clutch connected to the artificial muscle motor with a Z-twist is a counterclockwise clutch only allowing counterclockwise rotation, and the one-way clutch connected to the artificial muscle motor with an S-twist is a clockwise clutch only allowing clockwise rotation.

8. The subminiature drone of claim 7, wherein the propeller connected to the counterclockwise clutch is a forward propeller, and the propeller connected to the clockwise clutch is a reverse propeller.

9. The subminiature drone of claim 1, wherein the artificial muscle motors arranged to face each other across the body unit have different twists among Z-twist and S-twist.

10. The subminiature drone of claim 1, wherein the artificial muscle motors include: a rear artificial muscle motor with an S-twist disposed at the rear of the body unit, a right artificial muscle motor with a Z-twist disposed at the right side, a front artificial muscle motor with a Z-twist disposed at the front side, and a left artificial muscle motor with an S-twist disposed at the left side.

11. The subminiature drone of claim 1, wherein the upper fixing member includes:
an upper support frame protruding from the upper end of the body unit;
a plurality of upper circular frames coupled to the upper support frame;
at least two upper fixing frames radially disposed from each upper circular frame toward its center; and
a plurality of upper coupling members disposed at the center of the radially disposed upper fixing frames to fix the top ends of the artificial muscle motors.

12. The subminiature drone of claim 11, wherein the upper circular frames are located at the same level as the propellers.

13. The subminiature drone of claim 1, wherein the lower fixing member includes:
a plurality of lower fixing frames extending from the lower end of the body unit to support the artificial muscle motors;
a plurality of lower side wall frames, each having a bore that accommodates one of the artificial muscle motors therein and being supported by one of lower fixing frames; and
a plurality of lower coupling members arranged between the lower ends of the artificial muscle motors and the lower fixing frames to fix the artificial muscle motors.

14. A method of operating a subminiature drone, the method comprising:
providing a subminiature drone including a body unit; an upper fixing member connected to an upper end of the body unit; a lower fixing member connected to a lower end of the body unit; a plurality of artificial muscle motors disposed on the side of the body unit, positioned between and fixed to the upper and lower fixing members, generating rotational force by repeating twisting and untwisting; a plurality of propellers respectively connected to the artificial muscle motors to receive and rotate by the rotational force; a plurality of one-way clutches respectively arranged between the artificial muscle motors and the propellers to allow the propellers to rotate in one direction while restricting rotation in the opposite direction; and a battery unit electrically connected to the artificial muscle motors.
applying an ON voltage from the battery unit to both ends of the artificial muscle motors to allow the voltage-applied artificial muscle motors to rotate in a first direction and allow the propellers to rotate in the first direction by transmitting the rotation of the artificial muscle motors through the one-way clutches to the propellers; and
removing the applied voltage or applying a reference voltage lower than the ON voltage to the artificial muscle motors to allow the artificial muscle motors to rotate in a second direction opposite to the first direction and restrict the propellers from rotating in the second direction due to the one-way clutches not transmitting the rotation of the artificial muscle motors to the propellers.

15. The method of claim 14, wherein each of the artificial muscle motors is conductive nanomaterial yarn having Z- or S-twists and includes a drive motor part with a polymer impregnated in part of the yarn and a return spring part not impregnated with the polymer,
when the ON voltage is applied to the artificial muscle motor, Joule heating generated in the yarn causes the polymer in the drive motor part to expand in volume, rotating the drive motor part in the first direction which is an untwisting direction, and
when the voltage is removed or reduced below the ON voltage level, the expanded polymer contracts, allowing the drive motor part to rotate in the second direction which is an original twist direction.

16. The method of claim 15, wherein the drive motor part rotates in the untwisting direction, the return spring part twists further to store a rotational energy, and while the drive motor part rotates in the original twist direction, the return spring part transfers the stored rotational energy to the drive motor part to restore its original twist count.

17. The method of claim 15, wherein the one-way clutch associated with the artificial muscle motor having Z-twist is a counterclockwise clutch allowing only counterclockwise rotation, and the one-way clutch associated with the artificial muscle motor having S-twist is a clockwise clutch allowing only clockwise rotation,
when the driving motor part rotates in the first direction, the one-way clutch transmits rotational force of the driving motor part to rotate the propeller,
when the driving motor part rotates in the second direction, the one-way clutch blocks transmission rotational force of the driving motor part to restrict reverse propeller rotation.

18. The method of claim 15, wherein the artificial muscle motors include a rear artificial muscle motor with an S-twist disposed at the rear of the body unit, a right artificial muscle motor with a Z-twist disposed at the right side, a front artificial muscle motor with a Z-twist disposed at the front side, and a left artificial muscle motor with an S-twist disposed at the left side,
when ON voltage is applied to the rear artificial muscle motor and the front artificial muscle motor at the same level and ON voltage is applied to the right artificial muscle motor and the left artificial muscle motor at the same level, the drone operates the an ascent mode.

19. The method of claim 18, wherein, when ON voltage applied to the rear artificial muscle motor is higher than ON voltage applied to the front artificial muscle motor, the drone moves from rear to front.

20. The method of claim 19, wherein, when ON voltage applied the right artificial muscle motor is higher than ON voltage applied to the left artificial muscle motor, the drone moves left, and
when ON voltage applied the left artificial muscle motor is higher than ON voltage applied to the right artificial muscle motor, the drone moves right.
